(19) United States
(12) Patent Application Publication
(10) Pub. No.: US 2025/0056006 A1
(43) Pub. Date: Feb. 13, 2025

(54) APPLICATION BASED RATE-DISTORTION OPTIMIZATION IN VIDEO COMPRESSION

(71) Applicant: MELLANOX TECHNOLOGIES, LTD., Yokneam (IL)

(72) Inventors: Dotan David Levi, Kiryat Motzkin (IL); Yury Shvartzman, Raanana (IL); Eyal Frishman, Hod Hasharon (IL); Dror Porat, Haifa (IL); Eshed Ram, Nofit (IL); Ohad Markus, Haifa (IL); Limor Martin, Givatayim (IL)

(21) Appl. No.: 18/230,877

(22) Filed: Aug. 7, 2023

(51) Int. Cl. H04N 19/147; H04N 19/14; H04N 19/172; H04N 19/176

(52) U.S. Cl. CPC H04N 19/147; H04N 19/14; H04N 19/172; H04N 19/176

(57) ABSTRACT

Systems and methods herein are for a video encoder to be associated with an interface that is to receive, from an application, at least one metric that is associated with a quality preference for video compression to be performed by the video encoder and that is to provide a weight map to enable the video encoder to perform rate-distortion optimization (RDO) for received frames from the application using the weight map to weigh one or more first blocks associated with an individual one of the frames more than one or more second blocks associated with the individual one of the frames.

### TECHNICAL FIELD

At least one embodiment pertains to a video encoder to perform rate-distortion optimization (RDO). For example, an application provides at least one quality preference to enable the RDO for received frames using different weights for different blocks in a video frame.

### BACKGROUND

Rate-distortion optimization (RDO) may be used to support decision-making pertaining to selection of a mode for coding from different available modes in video encoding, such as in H.264/AVC standards. Such modes can offer different distortion reduction or trade-off approaches. The selection of a mode may be performed to address distortion using a rate constraint, for instance. For example, in H.264/AVC video encoding standards, RDO may be provided by allowing selection from intra mode and inter mode but can also extend to selection of a skip mode where each of such modes support different approaches to compression of video data. RDO can be used to determine motion vectors or prediction directions to be used with certain modes, including with inter or intra modes, and can be used to perform aspects of the video encoding. The aspects may include spatial domain transform, quantization, and entropy encoding. From the aspects performed, a selection may be made to perform inter or intra mode coding to handle, wholly, the video encoding requirements, based in part on a minimal rate-distortion cost (RD-cost) for at least a macroblock of a frame. RDO may be used with other standards as well, including with MPEG2 and MPEG4. However, even with RDO, such video encoding standards, including AVC, HEVC, VP9, AV1, and VVC, remain based on human eye limitations with respect to sensitivity to lower frequency; sensitivity to luma relative to chroma; and sensitivity to temporal changes.

### BRIEF DESCRIPTION OF DRAWINGS

FIG. 1 illustrates a system that is subject to embodiments of an application based rate-distortion optimization in video compression;

FIG. 2 illustrates aspects of a system associated with application based rate-distortion optimization in video compression, according to at least one embodiment;

FIG. 3 illustrates further aspects of the system associated with application based rate-distortion optimization in video compression, according to at least one embodiment;

FIG. 4 illustrates computer and processor aspects of a system associated with application based rate-distortion optimization in video compression, according to at least one embodiment;

FIG. 5 illustrates a process flow for a system associated with application based rate-distortion optimization in video compression, according to at least one embodiment;

FIG. 6 illustrates yet another process flow for a system associated with application based rate-distortion optimization in video compression, according to at least one embodiment; and

FIG. 7 illustrates a further process flow for a system associated with application based rate-distortion optimization in video compression, according to at least one embodiment.

### DETAILED DESCRIPTION

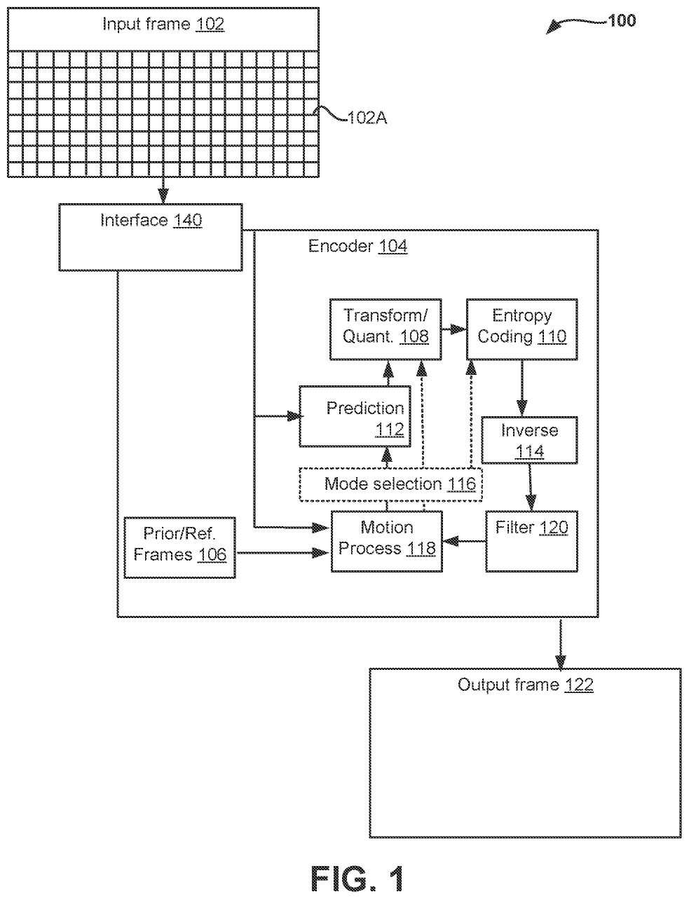

FIG. 1 illustrates a system 100 that is subject to embodiments of an application based rate-distortion optimization (RDO) in video compression, as detailed herein. The system 100 includes an encoder 104, such as a video encoder that can receive input frames 102 associated with a video stream, for instance, and that can provide output frames 122 that is a compressed or changed version of the input frames 102. In at least one embodiment, the encoder 104 may be based in part on one of an H.264 standard, an MPEG2 standard, an AVC standard, an HEVC standard, a VP9 standard, an AV1 standard, or a VVC standard. However, the encoder 104 may be any encoder standard that allows weighting input, such as by mode selection using a quantization parameter (QP).

In aspects of video encoding, the selection may be made to perform inter or intra mode coding. The selection may determine, how many bits the encoder is willing to sacrifice in order to conceal and/or eliminate a distortion. The trade-offs associated with distortion may be different between different encoders. For example, the trade-offs may be between different user presets, different target bitrate (such as, possibly affecting a bit budget), and between different frames in a group of frames (GOP) to be encoded. In another example, a trade-off may include a possibility that some distortion occurs, within a frame, and that is not a reference to other frames and so, the distortion may not propagate further in the encoding.

Video compression may require intensive computation workloads with present state-of-the-art compression ratios providing 1/200 to 1/1000 compression but requiring more compute resources to perform such compression. However, with artificial intelligent and machine learning (AI/ML) workloads using large quantities of images and video, autonomous cars generating a large amount of video in each car, applications like smart cities requiring more video data, content created for entertainment requiring higher video resolution and more bit depth, and present-day remote-working video conferencing technologies, it is appreciated that video compression must be performed is more efficient manner. Further, it is appreciated that human eye limitations, along with the use of color space conversion and separation of luma (brightness) and chroma provide aggressive quantized or decimated features that may be limiting in providing quality video compression.

For example, a Fourier or other related transform may be performed on blocks within every frame to convert data therein to a frequency domain and to allow quantization or discarding of information based on select frequencies. In doing so, transform coefficients at lower frequencies may be less aggressively quantized than those of higher frequency. Separately, motion estimation may be used to capture and encode movements across video frames. While all such aspects attempt to improve video compression, they may all serve a similar goal to allow an encoder to compress video into smaller bitstreams by eliminating noise, artifacts, allowing at least more intensive motion estimation and exploiting temporal and spatial redundancy.

In view of all such benefits, encoders may differ based in part on selections of proper tool(s) to enable aspects therein to provide economy of bits, such as, to enable selection of input frames 102 and selection of areas (such as provided by macroblocks (MBs) 102A) within those frames, and other such approaches that may be defined within the encoder as different modes that may require more bits to ensure a desired quality. An RDO may be provided within a mode selection module 116 of an encoder 104 to address such requirements by the use of RDO metrics, such as Sum of Squared Errors (SSE) or Sum of Transformed Differences (SATD) to determine a cost associated with each selection made and to enable a selection based on the cost. However, such selections may be less correlated with a subjective perceptual quality. For example, there may be modes available with the encoder 104 to add more sophisticated tools of compression. Such modes may affect an ability of the RDO metrics to predict a quality that is intended using the selection. In one instance, while a visual quality metric may correspond in the SSE RDO metric using Peak Signal-to-Noise Ratio (PSNR), this may be a poor predictor to the quality assessment.

Further RDO metrics allow further mode selection, including Video Multimethod Assessment Fusion (VMAF), Structural Similarity Index (SSIM), Multi Scale SSIM (MS-SSIM), and the aforementioned PSNR. However, addressing temporal effect remains for the encoder 104, as it may be done on only a frame level using such further RDO metrics. Distortion may be determined as a difference from the original image. In some applications, however, a focus of the application may be towards avoiding objectionable visual artifacts, rather than minimizing this distortion. For such applications, a user may not be a human observer, but an AI/ML model, for instance. The AI/ML model may not need RDO metrics based on a human visual system and therefore many of such RDO metrics may be less suitable or relevant.

In at least one embodiment, the system 100 for application based RDO in video compression enables an application that intends to use an encoder 104 to provide a metric that is pertinent to the application and according to which the encoder 104 is to perform the video compression. For example, the encoder 104 (also referred to herein as a video encoder) can receive transform coefficients or parameters, such as QPs from an interface 140, which in turn uses a metric provided by an application to determine weights to be attached to certain blocks associated with a video frame and to enable weights to those blocks differently than other blocks, in the encoder 104. The interface 140 is used interchangeably herein with an application-aware interface. The interface 140 is application-aware as it is adapted to inform the application of capabilities associated there with (or with its associated encoder 104) and to initiate receipt of the at least one metric from the application. The interface 140 provides a weight map of such weights to the encoder 104. As a result, application based RDO preserves video quality in portions of a video frame that are pertinent to the application.

In at least one embodiment, an interface 140 is part of a processor or an execution unit within the processor. Further, the encoder 104 is also part of a same or a different processor or a same or a different execution unit within the processor. The interface 140 is to receive a metric from the application. The metric may be associated with preferences of the application for its video compression requirements. Further, in at least one embodiment, the interface 140 may initially provide its abilities to an application to enable receipt of the metric. The interface 140 is to generate a weight map from the metric. The interface 140 has an application level awareness and performs a calculation of the weights of blocks within a frame based at least in part on the metric provided by the application. For example, the metric is a quality metric that is a preference of the application. In one example, an application for a classification ML model may require or prefer higher weights for certain blocks associated with a video frame having objects therein versus other blocks associated with the video frame having the background therein.

In at least one embodiment, the block subject to weighting may be subject to a further noise estimation algorithm that is one or more of temporal or spatial. This enables lower weights to individual blocks afflicted with stronger noise in addition to the weights associated with the weight map. Further, the weights for the weight map can be determined based in part on edges within a frame having the blocks. Still further, the weights for the weight map may be derived from an output of a detection or classification model running on the image to detect or classify aspects within the image, such as objects relative to backgrounds. Even further, the weights for the weight map may be determined based at least in part on visual quality metrics as part of the metrics from the application. For example, the visual quality metrics may include Extended Perceptually Weighted PSNR (XPSNR) or Perceptually Weighted PSNR (WPSNR).

In at least one embodiment, information or an output of the interface 140 may be used with the encoder 104 that is made agnostic to the metric. The weights provided by the interface 140 may be provided as a map of weights in an input to the encoder 104 or any execution unit of a processor performing the RDO. This allows a result of the RDO to select a mode for video compression that is, ultimately, preferential for the application. Such aspects in the system 100 and its supported method, therefore, divide the RDO into two parts. In one part, the system 100 and its supported method allow an application to control weights associated with the RDO. In a second part, the system 100 and its supported method allows the encoder 104, which may be performed wholly by an execution unit of a processor or a processor itself, to be agnostic. This is so that an outcome of the encoder 104 is substantially without performance loss.

In at least one embodiment, with software aspects of an encoder 104 herein, the system 100 and its supported method are also able to perform video compression using the weight map without sharing secrets associated with the application. For example, some applications may otherwise need to inform as to specific blocks to be subject to different processing than other blocks during video compression. One instance is of a security camera application may require special treatment to video of faces or regions that provide more information than other regions of the security camera application. The video may be classified in the display. A secret may be to inform about scaling and weighting in a pixel domain that need not be shared in the system 100 and in its supported method herein. In at least one embodiment, an application programming interface (API) may have a weight map for each frame. A classification for edges, face detection, or other object detection may be supported. The API receives a parameter for a sequence and for the frames of the sequence. A weight map provides weights for one or more blocks for every frame for the video compression to be perform by the encoder 104. As a result, a bitstream from the encoder 104 may be lower in terms of bandwidth. In addition, artificial intelligence (AI) or machine learning (ML) applications can benefit from this approach as the underlying data is not compromised by the application based RDO.

In at least one embodiment, an RDO may be determined with any metric that is classic or weighted. However, the RDO may be determined using reference to the previously encoded and reconstructed frame. This approach will allow generative AI to be used with the application based RDO. In at least one embodiment, application based RDO can also address bit allocation and smart bit savings by aspects occurring in a rate controller that is part of or supportive to an encoder 104. For example, if a block of a frame is found to be similar to a co-located block of the frame, an energy of a residual is low. Then no matter the quantization performed, there may be no influence by the quantizer and there may be no need to allocate bits for such information.

In at least one embodiment, application based RDO in a video compression processes allows an application that intends to use an encoder 104 to provide a metric that is pertinent to the application, where the encoder 104 uses at least a weight map related to the metric to weigh different blocks associated with a video frame as part of a mode selection or to perform video compression. Particularly, a video encoder that is associated with an interface 140 can receive, from an application, a metric that is associated with a quality preference for the application. For example, the metric may be received in the interface 140 or in a rate controller aspect of the encoder 104.

The encoder 104 can support an RDO that is performed for at least one frame of the received frames from the application based in part on the metric, where the weight map is used to weigh one or more first blocks associated with an individual one of the frames more than one or more second blocks associated with the individual one of the frames. Further, one or more of the features of the RDO, the interface 140, and the encoder 104 may be performed in hardware (such as individual processors or individual execution units of a processor) so that there is no loss in performance pertaining to the quality of the video. Finally, an application may be capable of determining that the video encoder has such an ability to perform application based RDO and can provide the metric to the encoder 104 or the interface 140 before providing the video stream.

The application based RDO can address bit allocation and smart bit savings during video compression conducted in blocks of a frame may be performed in a rate controller based on findings within certain blocks. However, to also address blocks that might have similar content to a collated block or object within the block that result in low energy of the residuals in making such findings and that reduce the effect of quantization performed, the system 100 and its associated method enable an application to provide at least one metric to be used to perform weighting in the RDO. Therefore, applications such as video conferencing, AI/ML, facial recognition, etc., can provide at least one metric that is pertinent to its respective needs which may pertain to a specific image standard, such as VMAF, SSIM, MS-SSIM, PSNR, etc. The metric can be the basis of weighting in the RDO for the application's video frames.

In at least one embodiment, FIG. 1 provides an encoder 104 that is subject to H.264 encoding. The encoder 104 includes modules in hardware or software, such as a prediction module 112, a transformation and quantization (T and Q) module 108, and an entropy coding module 110. There may be further modules, such as an inverse module 114, a filter module 120, a motion process module 118 (to support motion estimation and related aspects), and a prior or reference frames module 106. The application based RDO herein does not have effect on a decoding process for a bitstream provided from the encoder 104 that includes the output frame 122. For example, the decoding process may be according to the H.264 decoding or other decoding relevant to the encoding format used in the encoder 104 and particularly in the entropy coding module 110.

A bitstream of frames to be compressed may include an input frame 102 that can be subject to segmentation into units of MBs 102A. In at least one embodiment, application based RDO can support different sizes of MBs including, but not limited to 8×8, 8×16, 16×8, 4×4, and 16×16. The MBs likely correspond to displayed pixel data obtained at the location of the blocks. The prediction module 112 can generate a prediction MB that can be used to generate residual data reflective of data subject to quantization, as part of the application based RDO and for video compression. There may be multiple prediction options associated with a prediction module 112, including intra prediction that is associated with previously encoded data that is from a current frame, such as the input frame 102. Another option associated with a prediction module 112 includes inter prediction that uses encoded data from other previously encoded frames, namely reference frames, such as from the reference frames module 106. These reference frames can appear before or after the current frame, in the display order and may be associated with motion compensation, such as motion process module 118 that uses previously coded frames, such as provided from the prior or reference frames module 106.

Yet another option associated with a prediction module 112 includes the use of different prediction block sizes that is available to both, the intra prediction and inter prediction options. The use of different prediction block sizes of the MBs 102A can change an accuracy associated with the predictions. A further option associated with a prediction module 112 includes the use of multiple frames during prediction, which is available in the inter prediction option to provide better accuracy in the predictions. A still further option is to skip MB data or residual data so that the encoder 104 itself performs an inference of the MB data based in part on the prediction MB.

Intra prediction may be based at least in part on spatial data within an input frame 102, where MBs generated as part of the intra prediction that is distinct from the MBs 102A of the input frame 102. Residual data may be residual MBs generated by a subtraction of the prediction MB, from the current MB. The residual MB can be subject to transformation, quantization, and entropy coding in the provided modules 108, 110 depending on a mode selected by a mode selection module 116 that performs the RDO, for instance. Further, in the encoder 104, quantized data may be re-scaled and inverse transformed in the inverse module 114. An output of the inverse module 114 may be filtered and combined with the prediction MB in the prediction module 112. Motion estimation from the motion process module 118 may be included. The result may be a reconstructed MB that is provided to the prior or reference frames module 106 for further predictions.

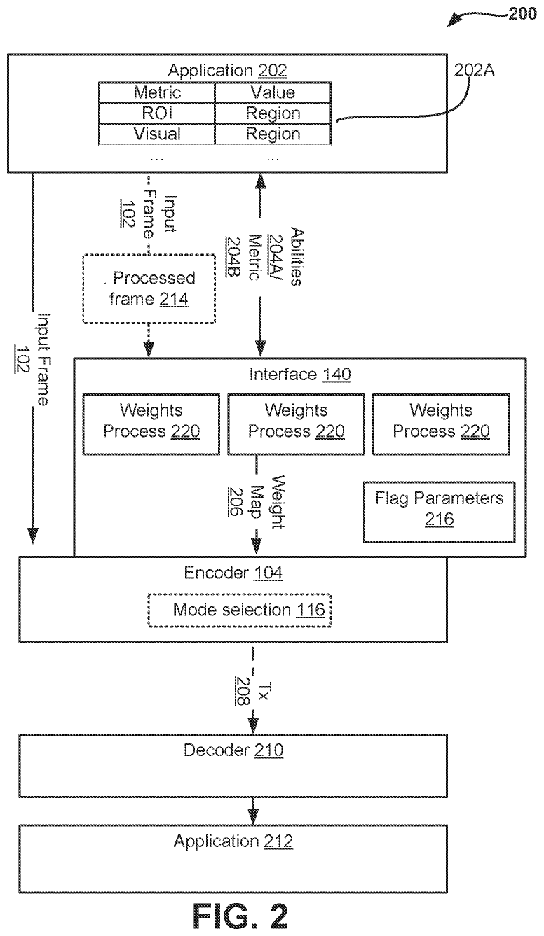

FIG. 2 illustrates aspects 200 of a system associated with application based rate-distortion optimization in video compression, according to at least one embodiment. FIG. 2 describes further details of an application 202 interfacing with the encoder 104 via an interface 140 to perform aspects of the application based RDO. While certain predication options, as discussed with respect to FIG. 1, are available in the encoder 104 for video compression, one or more of these options may be combined to be part of the modes available for selection using RDO. Further, other than the prediction module 112 supporting mode selection, the mode selection module 116 allows the encoder 104 to adjust a QP within a mode, such as within an inter mode. In at least one embodiment, a rate controller may be external or within the encoder 104 to provide QP associated with a rate control for the bitstream generated from the encoder 104. This may be performed to return a compressed video bitstream that provides maximum decoded quality but also that is minimal on the coded bitrate side.

In at least one embodiment, to enable an application 202 to provide specific input to be associated with the application based RDO, abilities 204A of the encoder 104 to support application based RDO may be communicated to the application 202 before or after a request by the application 202. For example, an indication may be provided to the application 202 that the encoder 204 can receive a weight map 206 for an RDO based in part on a metric to be provided by the application 202. In another example, the metric is provided by the application 202 for the interface 140 irrespective of the encoder's abilities 204A, whereas one or more weight processes 220 of the interface 140 can process the metric to provide the weight map 206 to the encoder 104. Further, while illustrated closer to or part of the encoder 104, the interface 140 may be performed by software, hardware, firmware, APIs, drivers, or other callable or interface aspects that can be associated with the application 202.

In at least one embodiment, the weight map 206 is provided to enable the encoder 104 to use weights therein to change or affect weights otherwise used in at least a transformation and quantization module 108. For example, a block of residual data may be transformed using a transformation function. The transformation may be a, in a non-limiting example, 4×4 or 8×8 transformation function that provides coefficients that may be weights in a standard basis pattern. In at least one embodiment, certain codecs may support larger transformation sizes than a 4×4 or 8×8 transformation function. These weights may be modified using the weights from the weight map 206. For example, the coefficients may be quantized such that each coefficient rationed by an integer. The quantization can modify an effect of only some coefficients based in part on a QP, such as the weights from the weight map 206, instead of across an entire frame.

In an instance, QPs of higher values, as associated with certain weights in the weight map 206, enable modification of some coefficients that are lower values and that are less relevant to an application, such as an AI/ML application. An output from such a modification may be higher compression in certain areas, but lower image quality in those area. Further, QPs of a higher value for certain areas in a frame, and as associated with certain weights from a weight map 206, can enable a modification of some coefficients that may be non-zero to be maintained after quantization. This may provide better image quality with lower compression for certain areas of a frame on the decoded side. Further, the modification in the standard basis patterns can be used to perform an inverse from the residual data.

In at least one embodiment, there may be multiple weight processes 220 associated with the interface 140. The weight processes 220 may be provided in different or a same execution unit or may be different application programming interfaces (APIs), all having one or more weight map 206 designated for a metric. However, a single API may be an application aware API with different classes associated with different weight maps 206 to be provided for different metrics. Further, the weight map 206 may be for each frame or a collection of frames and may be provided, relevant to the metric, for the encoder 104. As such, in at least one embodiment, the input frames 102 may be received in the interface 140 to allow determination of a weight map 206 to be used with the input frame and with one or more subsequent frames.

In at least one embodiment, instead of the input frame 102, a processed frame 214 that may be a downsampled or filtered frame of the input frame 102, may be provided for the interface 140 to allow determination of a weight map 206 to be used with the input frame. A processed frame 214 may be processed to a color format conversion, in one non-limiting example. In at least one embodiment, weight maps 206 may be generated from at least a retained weight map 206 by changes to the weights therein based in part on the metric received. Further, the system and method herein support dynamic weighing with the determination of the weight map 206 being dynamically updated for subsequent input frames instead of a singular input frame 102.

In at least one embodiment, an application 202 can define a metric as part of a preference 204B, external to an encoder 104. As such, the encoder 104 performs no role in the metric received from the application 202. Further, the metric may be one that encoder 104 is not familiar with, differently than the RDO metrics described elsewhere herein that may include PSNR, SSIM, and MS-SSIM. The application 202 can, however, require specific weight to different pixels represented in the MBs. In at least one embodiment, the application 202 may include a table 202A that includes aspects determined as secrets related to its preferences. An application may include a manifest file with a key to ensure secure calls may be placed to the interface 140, along with the metrics 204B provided for a weight map 206.

In at least one embodiment, the application 202 does not communicate the blocks of a frame it requires to be processed in any special matter. For example, a security camera application may have special requirements for certain parts of a frame to be maintained in quality than other parts. A classification of video frames may be part of the secret, including information as to scaling and weighting in a pixel domain, which may not be shared. However, an API, such as a weight process 220, may be provided to map weights for each frame. In at least one embodiment, a classification, edge detection, face detection, or other object detection may be performed in the interface 140 using a parameter for sequence and for frames from the application 202. The weight map 206 generated may include a weight block for every frame. As the weights are specific to areas of the frame, an eventual bitstream from the encoder 104 will need fewer bits for certain applications but may allocate more bits for intense applications. For example, in the case of an AI/ML application, the regions of interest (ROI) may be specifically enabled by a metric of a sequence and a frame from the application. A table of weights for each MB may be generated, such as for an 8×8 pixel block that is associated with a specific MB.

In at least one embodiment, flag parameters 216 allow for further adjustments to the weight maps associated with the weight processes 220. For example, the flag parameters 216 may be used by the application to adjust frequency; sensitivity to luma, sensitivity to chroma, sensitivity to temporal changes, or other such aspects as deemed preferential to the application 202. The flag parameters 216 may be part of one or more of the abilities 204A communicated to the application 202 and the metrics 204B communicated to the interface 140 to allow selection by an application of at least one value associated with a flag parameter 216. In at least one embodiment, the encoder 104 may perform a noise estimation algorithm that is one or more of temporal, spatial, or a combination thereof, to provide noise information in addition to the weighting to be performed for an input frame 102. The encoder 104 may determine that the one or more second blocks associated with the individual one of the frames is subject to more noise, in the noise information, than the one or more first blocks associated with the individual one of the frames. The encoder 104 may perform additional weighting of the one or more first blocks and of the one or more second blocks based, at least in part, on the noise.

In at least one embodiment, the weight map 206 of an interface 140 includes weights that are based at least in part on one or more edges within the individual one of the input frames 102 or that are based at least in part on visual quality metrics of the at least one metric. Further, the weight map 206 of an interface 140 includes weights that are based at least in part on an output of a detection or classification model applied to the individual one of the input frames 102. In addition, the weight map 206 of an interface 140 includes weights that are based at least in part on visual quality metrics that may be part of the at least one metric 204B. The output bitstream is transmitted 208 to a decoder 210 on a receiver-side where it is decoded for an application 212. There need not be any modifications on the decoder 210 to provide the application based RDO herein.

For example, RDO may be performed in a mode selection module 116 of the encoder 104 and may include cycling through different prediction modes to select a prediction mode to be used for blocks of a frame, the frame themselves, or for multiple frames. As such, for every prediction mode, a prediction block (P) may be generated for a macroblock (MB), residuals are determined, transformation and quantization (T and Q) is performed (including the use of rate control or external influence on the quantization, such as the use of QPs from weight maps 206), a number of bits associated with coding the residuals is determined, the MB is reconstructed, and a distortion using original and reconstructed MBs are determined along with a cost. Then, based at least in part on the cost for all the modes cycled through, a mode selection is performed to cause at least the prediction and residuals to be used with the entropy-coding of the original frame and at least some subsequent frames, to generate output frame 122 for transmission 208 to the decoder 210.

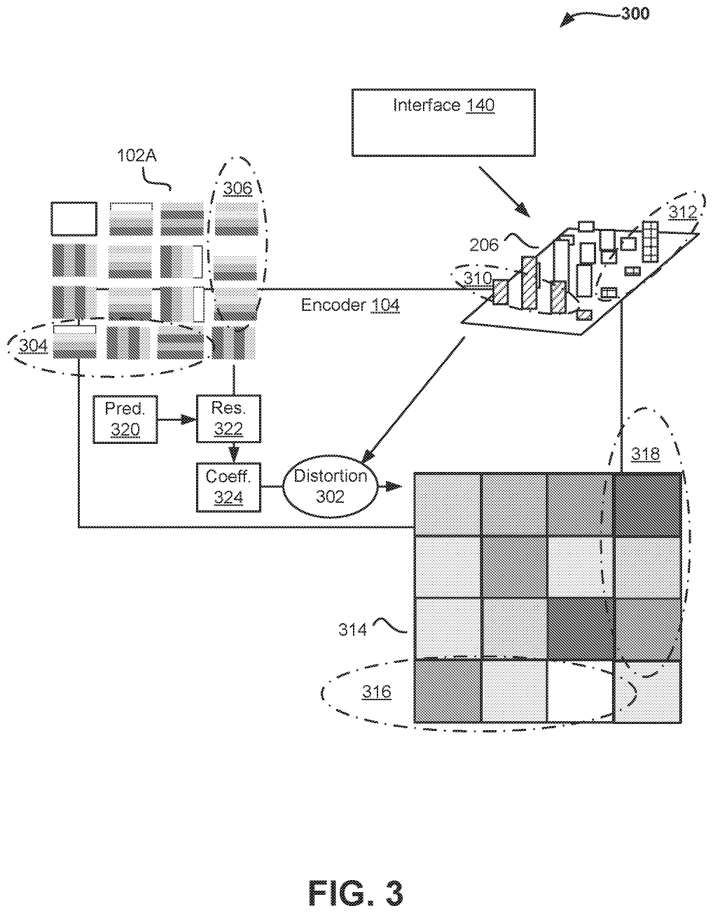

FIG. 3 illustrates further aspects 300 of the system associated with application based rate-distortion optimization (RDO) in video compression, according to at least one embodiment. To influence the RDO process using the application provided metric, the system herein includes one or more processing units to enable the RDO to be performed on input frames 102 having MBs 102A, from an application 202, based in part on a weight map 206 that is associated with at least one metric of a quality preference 204B of the application. The weight map 206 provides first weights 310 to be associated with one or more first blocks 304 of the provided MBs 102A an individual one of the input frames 102. The weight map 206 also provides second weights 312 that is less than first weights 310 to one or more second blocks 306 of the provided MBs 102A of the individual one of the input frames 102.

In at least one embodiment, even though the weights are described in reference to the blocks 304, 306, the weights may be applied at the T and Q stage and may be applied to cause changes in distortion 302. For example, the coefficients 324 of the transform part of the T and Q stage may include distortions 302 that may be adjusted further by the weights applied from the weight map 206. For example, for each prediction mode 320, the transform outputs the coefficients 324, which are weighting value to be associated with a basis pattern, such as provided by an inverse module 114. Once weighted along with the weights from the weight map 206, the basis patterns can be used to reconstruct the blocks of the residuals 322. The reconstruction is represented as an image block 314 having weighted basis pattern with different influenced blocks 316, 318 pertaining to the different weights 310, 312 of the weight map 206. For example, the coefficients may be quantized, by a division or other change induced by the weights 310, 312. The quantization changes the coefficients 324 according to the weights 310, 312 providing the QP. In at least one embodiment, the output from the encoder 104 is a compressed bitstream that includes values for the quantized transform coefficients and information for the decoder to recreate the prediction MBs, as well as information for a structure of compression and the frame sequence. These values are converted into binary codes using, for instance, Variable Length Coding (VLC), prior to transmission 208.

In at least one embodiment, the one or more processing units are further to perform a noise estimation algorithm that is one or more of temporal or spatial, or a combination thereof, to provide noise information. A determination can be made that the one or more second blocks 306 associated with the individual one of the input frames 102 is subject to more noise, in the noise information, than the one or more first blocks 304 associated with the individual one of the input frames 102. Further, additional weighting may be performed of the one or more first blocks 304 and of the one or more second blocks 306 based, at least in part, on the noise.

In at least one embodiment, one or more processing units adapted for application based RDO are further to determine the first weights and the second weights of the weight map 206 based at least in part on one or more edges within the individual one of the frames or based at least in part on visual quality metrics of the at least one metric. The one or more processing units are further to perform a detection or classification model on the individual one of the frames. Then, the first weights and the second weights determined for the weight map 206 may be based at least in part on an output of the detection or classification models. Therefore, at least one of the weight processes 220 may perform the detection or classification model to determine aspects of the input frame 102 to be weighed differently based in part on a metric from the application. For example, a metric of a sequence and a frame from the application may guide the detection or classification model as to specific objects or features to be classified and to enable selection of blocks to be weighed differently as part of the RDO. Further, the at least one metric may include visual quality metrics and the one or more processing units are further to determine the first weights and the second weights based at least in part on visual quality metrics of the at least one metric.

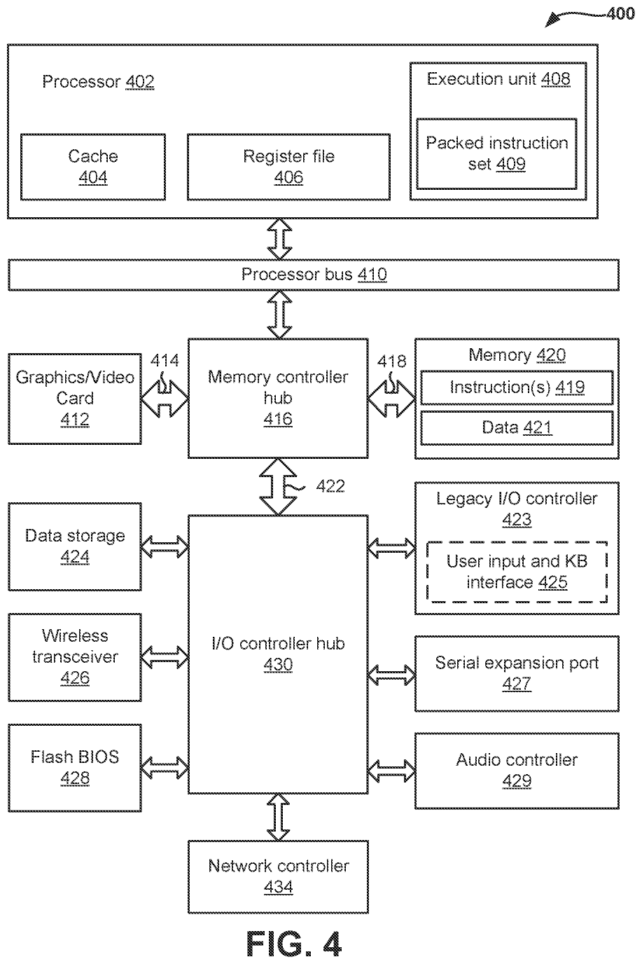

FIG. 4 illustrates computer and processor aspects 400 of a system associated with application based rate-distortion optimization in video compression, according to at least one embodiment. For example, one or more processors 402 may include one or more processing or execution units 408 that can perform an application 202 that is associated with video data. Further, the one or more processing units 408 can perform aspects of an encoder 104 and of an interface 140. The one or more execution units 408 can determine a feature associated with an encoder 104 and that is associated with at least one metric for a quality preference 204B of the application 202. The one or more execution units 408 can generate a weight map 206 that is associated with the metric to enable the video encoder to perform rate-distortion optimization (RDO) for received frames from the application using the weight map. For example, the application based RDO herein can use the weight map to weigh one or more first blocks associated with an individual one of the frames more than one or more second blocks associated with the individual one of the frames.

In at least one embodiment, the one or more execution units 408 are further to perform a noise estimation algorithm that is one or more of temporal or spatial, or a combination thereof, to provide noise information. The one or more execution units 408 can determine that the one or more second blocks associated with the individual one of the frames is subject to more noise, in the noise information, than the one or more first blocks associated with the individual one of the frames. The one or more execution units 408 can also perform additional weighting of the one or more first blocks and of the one or more second blocks based, at least in part, on the noise.

In at least one embodiment, the one or more execution units 408 are further to determine the weights in the weight map based at least in part on one or more edges within the individual one of the frames or based at least in part on visual quality metrics of the at least one metric; but can also determine the weights in the weight map based at least in part on an output of a detection or classification model performed on the individual one of the frames. In at least one embodiment, with the at least one metric including visual quality metrics, the one or more execution units 408 can perform a further determination of the weights in the weight map based at least in part on the visual quality metrics.

The computer and processor aspects 400 may be performed by one or more processors 402 that include a system-on-a-chip (SOC) or some combination thereof formed with a processor that may include execution units to execute an instruction, according to at least one embodiment. In at least one embodiment, the computer and processor aspects 400 may include, without limitation, a component, such as a processor 402 to employ execution units 408 including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data, and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

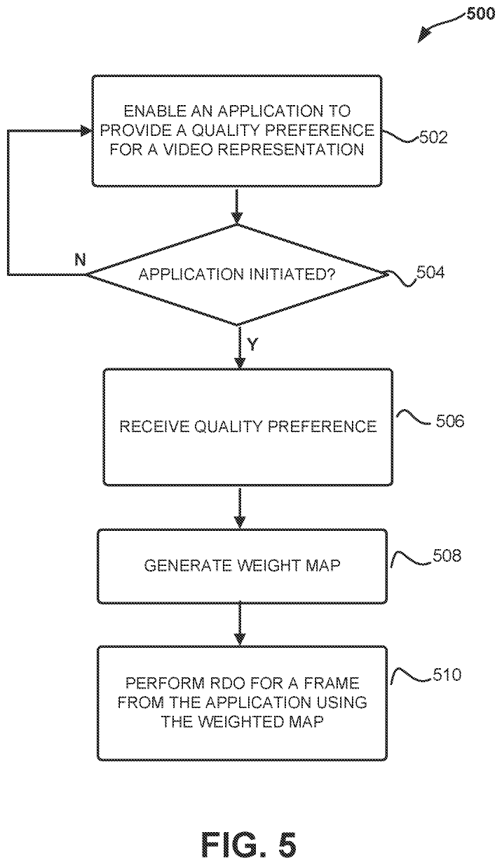

FIG. 5 illustrates a process flow or method 500 for a system associated with application based rate-distortion optimization in video compression, according to at least one embodiment. The method 500 includes enabling 502 an application to provide a quality preference for video data. For example, the application may include a video conferencing application, an AI/ML application, facial recognition application, etc., where each application may have different quality preferences of their video data specific to how the video data is consumed by the application. In at least one embodiment, the method 500 includes communicating that an encoder or a processor that is to process the video data is capable of application based RDO prior to the application providing its quality preferences. For example, this may be enabled by a driver of the encoder or processor communication with the application or by the use of APIs of the interface.

The method 500 includes determining or verifying 504 that at least one communication received from the application is associated with video data. The method 500 includes determining 506 a quality preference from the communication, where the quality preference includes at least one metric that is associated for the application. The at least one metric is associated with video compression to be performed by the video encoder on the video data having multiple frames. The method 500 includes generating 508 a weight map that is associated with the metric, such as by using at least one weight process of the interface. The method 500 further includes performing 510 an RDO for an individual one of the frames of the video data from the application based in part on using the weight map, where the performing 510 step uses the weight map to weigh one or more first blocks associated with an individual one of the frames more than one or more second blocks associated with the individual one of the frames.

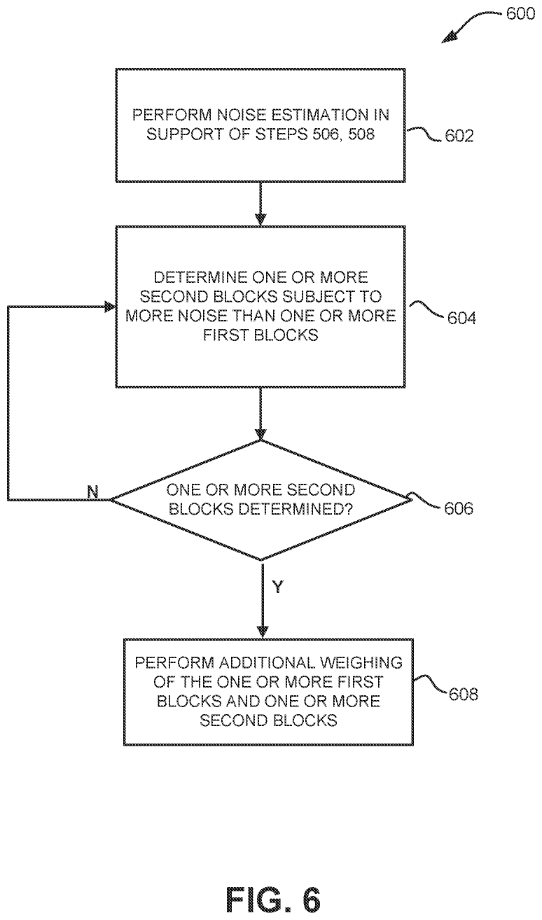

FIG. 6 illustrates yet another process flow or method 600 for a system associated with application based rate-distortion optimization in video compression, according to at least one embodiment. FIG. 6 may support one or more steps of the method 500 in FIG. 5. In at least one embodiment, the method 600 may include a step or a sub-step for performing 602 a noise estimation algorithm that is one or more of temporal or spatial to provide noise information. This step 602 may be in support of one or more of steps 506, 508 of the method 500 in FIG. 5. The method 600 includes determining 604 noise from the noise information for the one or more first blocks and for the one or second blocks that are associated with the individual one of the frames. The method 600 includes verifying 606 that the one or more second blocks is subject to more noise, in the noise information, than the one or more first blocks. The method 600 includes performing additional weighting 608 of the one or more first blocks and of the one or more second blocks based, at least in part, on the noise. This step 608 may be in addition to the weight map of step 510 in the method 500 of FIG. 5.

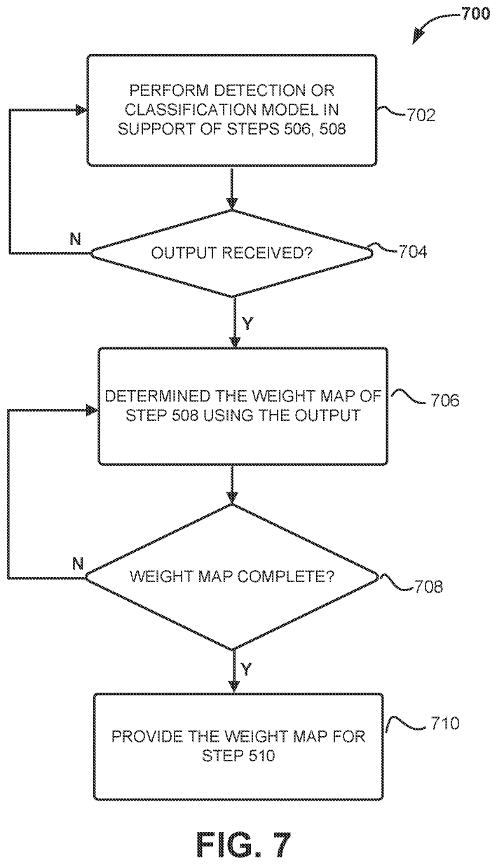

FIG. 7 illustrates a further process flow for a system associated with application based rate-distortion optimization in video compression, according to at least one embodiment. FIG. 7 may support one or more steps of the method 500 in FIG. 5. The method 700 includes performing 702 a detection or classification model on the individual one of the frames. For example, the detection or classification model is to perform a classification for edges or a detection for faces or other objects, altogether forming features of the model. A verification 704 may be performed that the detection or classification model results in a feature output. For example, multiple features may require selection of one feature that is a dominant feature. In at least one embodiment, the method 700 includes determining 706 weights to be part of the weight map of step 508, based at least in part on an output of the detection or classification model. The method 700 may include verifying 708 that the weight map is complete before it is provided 710 for performing the RDO in step 510.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A video encoder to be associated with an interface that is to receive, from an application, at least one metric that is associated with a quality preference for video compression to be performed by the video encoder and that is to provide a weight map to enable the video encoder to perform rate-distortion optimization (RDO) for received frames from the application using the weight map to weigh one or more first blocks associated with an individual one of the frames more than one or more second blocks associated with the individual one of the frames.

2. The video encoder of claim 1, wherein the interface is an application-aware interface that is adapted to inform the application of capabilities associated there with and to initiate receipt of the at least one metric from the application.

3. The video encoder of claim 1, further comprising:
at least one execution unit associated with the video encoder to perform the RDO or to comprise the interface.

4. The video encoder of claim 1, further comprising an execution unit to:
perform a noise estimation algorithm that is temporal, spatial, or a combination thereof, to provide noise information;
determine that the one or more second blocks associated with the individual one of the frames is subject to more noise, in the noise information, than the one or more first blocks associated with the individual one of the frames; and
perform additional weighting of the one or more first blocks and of the one or more second blocks based, at least in part, on the noise.

5. The video encoder of claim 1, wherein the weight map comprises weights that are based at least in part on one or more edges within the individual one of the frames or that are based at least in part on visual quality metrics of the at least one metric.

6. The video encoder of claim 1, wherein the weight map comprises weights that are based at least in part on an output of a detection or classification model applied to on the individual one of the frames.

7. The video encoder of claim 1, wherein the at least one metric comprises visual quality metrics and wherein the weight map comprises weights that are based at least in part on the visual quality metrics.

8. A system comprising:
one or more processing units to enable rate-distortion optimization (RDO) to be performed on received frames from an application based in part on a weight map that is associated with at least one metric of a quality preference of the application, the weight map to provide first weights to one or more first blocks associated with an individual one of the frames and to provide second weights that is less than first weights to one or more second blocks associated with the individual one of the frames.

9. The system of claim 8, wherein the one or more processing units are further to:
perform a noise estimation algorithm that is temporal, spatial, or a combination thereof, to provide noise information;
determine that the one or more second blocks associated with the individual one of the frames is subject to more noise, in the noise information, than the one or more first blocks associated with the individual one of the frames; and
perform additional weighting of the one or more first blocks and of the one or more second blocks based, at least in part, on the noise.

10. The system of claim 8, wherein the one or more processing units are further to:
determine the first weights and the second weights based at least in part on one or more edges within the individual one of the frames or based at least in part on visual quality metrics of the at least one metric.

11. The system of claim 8, wherein the one or more processing units are further to:
perform a detection or classification model on the individual one of the frames; and
determine the first weights and the second weights based at least in part on an output of the detection or classification model.

12. The system of claim 8, wherein the at least one metric comprises visual quality metrics and the one or more processing units are further to:
determine the first weights and the second weights based at least in part on visual quality metrics of the at least one metric.

13. A system comprising:
one or more processing units to perform an application that is associated with video data, to determine a feature associated with a video encoder and that is associated with at least one metric for a quality preference of the application, and to generate a weight map that is associated with the metric to enable the video encoder to perform rate-distortion optimization (RDO) for received frames from the application using the weight map to weigh one or more first blocks associated with an individual one of the frames more than one or more second blocks associated with the individual one of the frames.

14. The system of claim 13, wherein the one or more processing units are further to:
perform a noise estimation algorithm that is temporal, spatial, or a combination thereof, to provide noise information;
determine that the one or more second blocks associated with the individual one of the frames is subject to more noise, in the noise information, than the one or more first blocks associated with the individual one of the frames; and
perform additional weighting of the one or more first blocks and of the one or more second blocks based, at least in part, on the noise.

15. The system of claim 13, wherein the one or more processing units are further to:
determine the weights in the weight map based at least in part on one or more edges within the individual one of the frames or based at least in part on visual quality metrics of the at least one metric.

16. The system of claim 13, wherein the one or more processing units are further to:
perform a detection or classification model on the individual one of the frames;
determine the weights in the weight map based at least in part on an output of the detection or classification model.

17. A method for a video encoder, comprising:
receiving at least one metric that is associated with a quality preference for an application associated with video compression to be performed by the video encoder; and
performing rate-distortion optimization (RDO) for received frames from the application based at least in part on a weight map associated with the at least one metric, the weight map to weigh one or more first blocks associated with an individual one of the frames more than one or more second blocks associated with the individual one of the frames.

18. The method of claim 17, further comprising:
performing a noise estimation algorithm that is temporal, spatial, or a combination thereof, to provide noise information;
determining that the one or more second blocks associated with the individual one of the frames is subject to more noise, in the noise information, than the one or more first blocks associated with the individual one of the frames; and
performing additional weighting of the one or more first blocks and of the one or more second blocks based, at least in part, on the noise.

19. The method of claim 17, further comprising:
determining weights to be part of the weight map based at least in part on one or more edges within the individual one of the frames or based at least in part on visual quality metrics of the at least one metric.

20. The method of claim 17, further comprising:
performing a detection or classification model on the individual one of the frames; and
determining weights to be part of the weight map based at least in part on an output of the detection or classification model.
